(19) United States
(12) Patent Application Publication
(10) Pub. No.: US 2015/0330567 A1
(43) Pub. Date: Nov. 19, 2015

(54) COMPONENT COMPRISING A METAL MATRIX REINFORCEMENT MEMBER AND METHOD OF FORMATION THEREOF

(71) Applicant: JAGUAR LAND ROVER LIMITED, Whitley, Coventry Warwickshire (GB)

(72) Inventors: Mike SHERGOLD, Warwick, Warwickshire (GB); David JAMESON, Warwick, Warwickshire (GB); Neil STEVENS, Northamptonshire (GB)

(21) Appl. No.: 14/654,517

(22) PCT Filed: Dec. 20, 2013
(86) PCT No.: PCT/EP2013/077730

§ 371 Date: Jun. 20, 2015

(30) Foreign Application Priority Data
Dec. 21, 2012 (GB) 1223197.3

(51) Int. Cl. F16S 5/00; B22D 21/04; B22D 19/02

(52) U.S. Cl. CPC F16S 5/00; B22D 19/02; B22D 21/04

(57) ABSTRACT

Embodiments of the invention provide a method of forming a component having an anchor portion for attachment of a further component thereto, the method comprising:

performing a casting operation to form a cast portion of the component, the anchor portion comprising at feast a portion of the cast portion and at least one metal matrix composite reinforcement member retained by the cast portion,

the anchor portion having a bore, the reinforcement member having a longitudinal axis having at least a component thereof substantially parallel to or coincident with a longitudinal axis of the bore, the anchor portion being arranged to allow a second component to be inserted into the bore thereof to enable the second component to be attached to the anchor portion.

### TECHNICAL FIELD

The present invention relates to a casting operation and to a method of casting a component.

### BACKGROUND

It is known to provide a cast aluminium component by casting molten aluminium into a mould. Aluminium and other relatively light metals such as aluminium alloy, magnesium or magnesium alloy may be used instead of heavier materials such as steel in order to reduce a weight of a component. This assists a manufacturer of a multi-component product such as a motor vehicle to control a weight of the product. However, aluminium has a relatively low Young's modulus (around 70 GPa). It follows that the strength properties of aluminium are less than those of steel. Therefore, if a light but stiff component is required to be formed from aluminium, it is typically necessary to use more material than would otherwise be required of a part made from a stiffer material such as steel (having a Young's modulus of around 207 GPa). The additional material required is normally distributed so as to increase the second moment of area of the component. Thus the geometry of the component is adjusted to increase stiffness of the component, for example bending and/or torsional stiffness or rigidity. In some applications, the available space into which a component must fit may be limited, requiring a stiffer material such as steel to be used in order to meet a required component stiffness specification. The use of steel however results in an increase in the weight of the component and is highly undesirable in some applications.

A portion of a cast component that may be particularly sensitive to stresses is an anchor portion that enables another component to be coupled thereto. The anchor portion may retain a bearing housing to which a shaft may be rotatably coupled to the component, or a fixing element such as a bolt or the like for attachment of another component thereto.

### SUMMARY Of THE INVENTION

Embodiments of the invention may be understood with reference to the appended claims. Aspects of the present invention provide a methods, a component, a system, a vehicle, an aircraft and a vessel.

In an aspect of the invention for which protection is sought there is provided a method of forming a component having an anchor portion for attachment of a further component thereto, the method comprising; performing a casting operation to form a cast portion of the component, the anchor portion comprising at least a portion of the cast portion and at least one metal matrix composite reinforcement member retained by the cast portion, the anchor portion having a bore, the reinforcement member having a longitudinal axis having at least a component thereof substantially parallel to or coincident with a longitudinal axis of the bore, the anchor portion being arranged to allow a second component to be inserted into the bore thereof to enable the second component to be attached to the anchor portion.

Embodiments of the present invention have the advantage that axial stress associated with attachment of a fixing element such as a bolt to an anchor portion of a component may be borne at least in part by the reinforcement member.

Some embodiments of the invention have the advantage that a component may be provided having an anchor portion that is capable of withstanding greater crush loads associated with fixing elements such as bolt crush loads before damage to the component occurs.

Some embodiments of the invention have the advantage that a component may be provided having an anchor portion that is capable of withstanding greater burst loads or hoop stresses.

The anchor portion may comprise a plurality of reinforcement members, for example elongate members arranged circumferentially around the bore of the anchor portion. The reinforcement members may be provided substantially parallel to one another. Alternatively the reinforcement members may be non-parallel.

It s to be understood that the component may be substantially entirely cast, the reinforcement member providing reinforcement of the anchor portion at least. The reinforcement member may be formed in part by casting matrix material around a reinforcing inclusion material such as a fibre material, optionally a woven fibre material.

The reinforcement member may be formed to be substantially surrounded by a portion of the cast portion of the component.

The method may comprise providing a metal matrix composite reinforcement member in the form of an elongate member, optionally an elongate rod member.

Advantageously the method may comprise providing the reinforcement member whereby the reinforcement member comprises a tube member having a bore formed at least partially therethrough.

The tube member may be substantially cylindrical.

The method may comprise providing the reinforcement member whereby the bore of the reinforcement member is substantially coaxial with the bore of the anchor portion.

The method may comprise forming the tube member to have a bore formed substantially entirely therethrough, the anchor portion having a corresponding bore substantially entirely therethrough.

The cast portion may be cast such that at least a portion of the bore of the tube member is coated with cast material.

The cast portion may be cast such that the reinforcement member is substantially wholly embedded within the cast portion such that the bore of the tube member is substantially fully coated in cast material of the cast portion.

Advantageously, forming the cast portion may comprise casting a bearing housing whereby at least a portion of the bearing housing is provided within the tube member.

The method may comprise providing a bearing assembly in the bearing housing.

The cast portion may be cast such that the bore of the tube member is substantially free of cast material.

The method may comprise providing a bearing assembly in the bore of the anchor portion.

Providing a bearing assembly may comprise providing a bearing race.

The method may comprise providing a rotary shaft member rotatably supported by the bearing assembly.

The anchor portion may be arranged to provide an anchor for a fixing element, the method comprising inserting a fixing element through the bore of the tube member.

The method may comprise applying a compressive load to the anchor portion by means of the fixing element, the compressive load having at least a component thereof parallel to an axis of the bore of the tube member.

The compressive load may be arranged to secure the fixing element to the component.

The fixing element may comprise a bolt member.

The method may comprise applying a compressive load to the anchor portion at least in part by means of a nut attached to the bolt member.

The metal matrix composite material of the reinforcement member may comprise an aluminium matrix composite material.

The method may comprise forming the cast portion from a molten material comprising aluminium.

The molten material may be one selected from amongst aluminium and an aluminium alloy.

The method may comprise placing the reinforcement member in a mould; and introducing molten metal into the mould to form at least a portion of a component.

The method may comprise forming the component to be an automotive or aerospace component.

The method may comprise forming the component to be a component of a suspension system.

In a further aspect of the invention there is provided a component having an anchor portion for attachment of a further component thereto, the component comprising:
a cast portion, the anchor portion comprising at least a portion of the cast portion and at least one metal matrix composite reinforcement member retained by the cast portion,
the anchor portion having a bore, the reinforcement member having a longitudinal axis having at least a component thereof substantially parallel to or coincident with a longitudinal axis of the bore, the anchor portion being arranged to allow a second component to be inserted into the bore thereof to enable the second component to be attached to the anchor portion.

The reinforcement member may be substantially surrounded by a portion of the cast portion of the component.

The reinforcement member may be in the form of a substantially elongate member, optionally a substantially elongate rod member.

Advantageously the reinforcement member comprises a tube member having a bore formed at least partially therethrough.

The bore of the tube member may pass substantially entirely through the tube member.

The component may be provided in combination with a bearing assembly, the bearing assembly being provided in the anchor portion.

In addition or instead the component may be provided in combination with a fixing element, the fixing element passing through the bore of the anchor portion.

The fixing element may be arranged to apply a compressive load to the anchor portion.

The fixing element may be arranged to be secured to the fixing element by means of the compressive load.

Advantageously, the metal matrix composite material of the reinforcement member may comprise an aluminium matrix composite material.

The cast portion may comprise aluminium.

The cast portion may be one selected from amongst aluminium and an aluminium alloy.

In a further aspect of the invention for which protection is sought there is provided a suspension system comprising a component according to a preceding aspect.

In a still further aspect of the invention for which protection is sought there is provided a motor vehicle comprising a component or a suspension system according to a preceding aspect.

In an aspect of the invention for which protection is sought there is provided an aircraft or vessel comprising a component according to a preceding aspect.

In one aspect of the invention for which protection is sought there is provided a method of forming a component having an anchor portion for attachment of a further component thereto, comprising:
providing a metal matrix composite tube member having a bore formed at least partially therethrough;
forming a component having a cast portion, the cast portion being cast whereby the component comprises an anchor portion, the anchor portion comprising the tube member, the tube member being held by the cast portion, the anchor portion being arranged to allow a second component to be inserted into the bore of the tube member thereby to anchor the second component to the anchor portion.

In a further aspect of the invention for which protection is sought there is provided a method of forming a component having an anchor portion for attachment of a further component thereto, the method comprising;
performing a casting operation to form at least a portion of the component, the anchor portion comprising at least a portion of the cast portion and at least one substantially elongate metal matrix composite reinforcement member retained by the cast portion, the anchor portion having a bore, the reinforcement member having a longitudinal axis substantially parallel to or coincident with a longitudinal axis of the bore, the anchor portion being arranged to allow a second component to be inserted into the bore thereof to enable the second component to be attached to the anchor portion.

The reinforcement member may comprise a rod, strip, bar or other form of metal matrix composite material.

The metal matrix composite used in embodiments of the invention including any aspect described herein may be in the form of lengths of fibre, optionally woven fibre.

Within the scope of this application it is envisaged that the various aspects, embodiments, examples, features and alternatives set out in the preceding paragraphs, in the claims and/or in the following description and drawings may be taken independently or in any combination. Features described with reference to one embodiment are applicable to all embodiments, unless there is incompatibility of features.

For the avoidance of doubt, it is to be understood that features described with respect to one aspect of the invention may be included within any other aspect of the invention, alone or in appropriate combination with one or more other features.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described with reference to one embodiment are applicable to all embodiments, unless such features are incompatible.

### BRIEF DESCRIPTION OF THE DRAWINGS

One or more embodiments of the invention will now be described, by way of example only, with reference to the accompanying figures in which:

FIG. 1 is a schematic illustration of known components showing (a) a clamped joint in an aluminium rod end with no steel Insert and (b) an aluminium rod end with a steel insert, the steel insert enabling a reduction in component radius;

FIG. 2 is a schematic illustration of an aluminium rod end according to an embodiment of the present invention: and

FIG. 3 is a schematic illustration of a cast aluminium component according to an embodiment of the present invention having a bearing housing provided therein.

### DETAILED DESCRIPTION

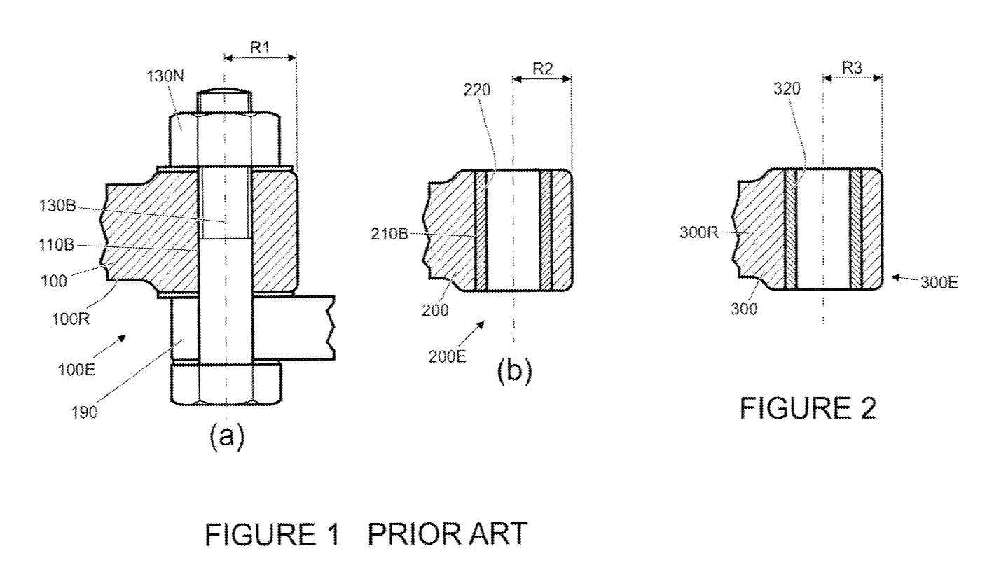

FIG. 1(a) shows an end portion 100E of a known cast aluminium component 100. The end portion 100E is enlarged relative to a rod portion 100R of the component 100 to provide an anchor portion for a fixing element. In the embodiment shown a bore 110B has been formed in the end portion 100E through which a bolt 130B has been passed in order to secure a second component 190 to the component 100. A nut 130N has been screwed onto a free end of the bolt 130B in order to apply a compressive load urging the second component 190 into abutment with the end portion 100E of component 100 in order to secure the second component thereto. The end portion 100E has a radius R1 with respect to a centreline of the bore 110B.

The value of R1 is selected to provide an end portion 100E that is sufficiently strong to resist the crush load exerted on the end portion 100E by the bolt 130B.

FIG. 1(b) shows an end portion 200E of a further known cast aluminium component 200. Like features of the arrangement of FIG., 1(b) to that of FIG. 1(a) are shown with like reference numerals incremented by 100. The end portion 200E is provided with a steel insert or bush 220 in the form of a length of hollow steel tube open at each end. The insert 220 is retained in the end portion 200E by an interference fit and provides additional strength to the end portion 200E. The strength properties of steel are greater than that of aluminium. Thus the radius of the end portion can be reduced to a value R2<R1 when the steel insert 220 is employed.

It is to be understood that in order to manufacture the rod 200, precision machining is required in order to form the bore 210B in which the insert 220 is provided, and provide a relatively tight interference fit for the insert 220 in the bore 210B. The aluminium end portion 200E must be of a diameter sufficient to enable the end portion 200E to withstand burst loads associated with the interference fit of the insert 220 in the end portion 200E.

FIG. 2 shows an end portion 300E of a cast aluminium rod 300R according to an embodiment of the present invention. Like features of the arrangement of FIG. 2 to that of FIG. 1(b) are shown with like reference numerals incremented by 100. The end portion 300E has an insert member 320 in the form of a hollow tube formed from an aluminium matrix composite (AMC). The AMC comprises alumina fibres impregnated with aluminium to form the insert member 320. The insert member 320 may be fabricated by wrapping the alumina fibres around a former to form a fibre preform before impregnating the preform with molten aluminium. In examples according to embodiments of the present invention, the AMC may comprise particle reinforcement. Such AMC material comprises uniformly dispersed particles at a specified volume fraction within a matrix of aluminium. Other arrangements are also useful. For example, other types of fibre and other methods of forming the composite structure are also useful. The AMC of the insert member 320 has greater strength properties than the aluminium of the remainder of the end portion 300E.

The insert member 320 is then inserted into a mould in which the rod 300R is subsequently cast. The insert member 320 thereby becomes cast into the end portion 300E of the rod 300R.

It is to be understood that because the insert member 320 is cast into the end portion 300E, it is retained in the end portion 300E by intimate bonding and/or mixing of aluminium comprised by the end portion 300E and aluminium poured into the mould when the rod 300R is cast. Accordingly, it is not necessary for the end portion 300E to withstand substantial burst stresses due to an interference fit of the insert member 320 as in the case of the known arrangement of FIG. 1(b) in which a steel insert member 220 is employed. Accordingly a radius of the end portion 300E may be reduced compared with that of the structure of FIG. 1. It is to be understood that because the insert member 320 comprises aluminium, problems due to contact between dissimilar metals such as corrosion and differential thermal expansion that are associated with known arrangements employing an insert member may also be substantially reduced or eliminated.

The AMC material of the insert member 320 has greater strength properties than the aluminium of the cast end portion. In examples according to embodiments of the invention, this provides improved localised strength properties at the bolted joint interface allowing for a reduced section and mass whilst also achieving strength properties that enable higher bolt preloads for increased robustness under varying tightening strategies.

In the embodiment of FIG. 2 an inner surface of the insert member 320 does not become coated with cast material during the casting operation. In some alternative embodiments the Inner surface of the insert member may arranged to be coated with cast material.

Embodiments of the present invention have the advantage that a cast aluminium component may be provided with an anchor portion to which a further component may be anchored, the anchor portion being capable of withstanding higher crush loads than known anchor portions.

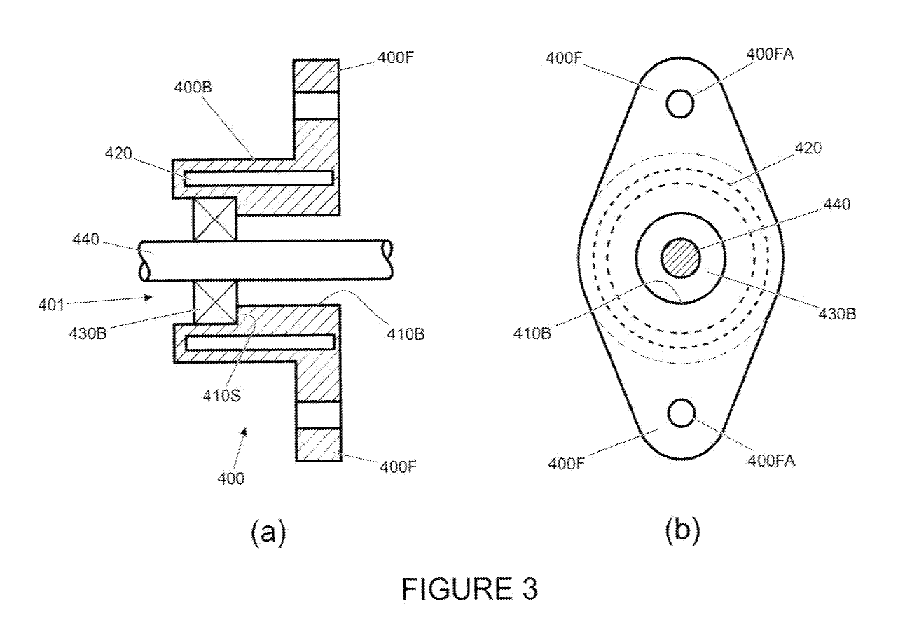

FIG. 3 shows a component 400 according to an embodiment of the invention in (a) cross-section and (b) front elevation. The component 400 is in the form of a cast aluminium bearing housing 400. The component 400 has a cast body portion 4008 cast so as to include a tubular insert member 420 formed from an aluminium matrix composite (AMC) material in the embodiment of FIG. 3 (and of FIG. 2) the insert member 420 is cylindrical. In the embodiment of FIG. 3 the insert member 420 is wholly embedded within the body portion 400B, being substantially entirely surrounded by aluminium metal when the component 400 is cast. A bearing support portion 401 is cast within the insert member 420 during casting of the component 400. The support portion 401 provides a means by which a bearing assembly 430B may be retained. The bearing support portion 401 is provided within a bore 410B formed through the body portion 400B of the component 400. The insert member 420 is arranged to be coaxial with the bore 410B, the bore 410B passing through the insert member 420.

The portion of the body portion 400B within the bore of the insert member 420 is shaped to define the bearing support portion 401. The bearing support portion 401 has a stepped diameter thereby providing a shoulder 410S with which the bearing assembly 430B may be placed in abutment. The shoulder 410S assists in preventing axial sliding of the assembly 430B beyond the shoulder 410S.

The bearing assembly 430B is retained within the bore 410B of the housing by means of an interference fit although other arrangements for retaining the bearing assembly 430B are also useful. The presence of the insert member 420 lends additional strength to the component 400 enabling it to withstanding stresses associated with the interference fit of the bearing assembly 430B in the form of burst loading or hoop stresses.

The hearing assembly 430B carries a shaft 440 and is arranged to allow rotation of the shaft 440 with respect to the body portion 400B.

The body portion 400B has a pair of mounting flanges 400F that project radially outwards from the body portion 400B at diametrically opposite locations of the body portion 400B in order to allow attachment of the component 400 to a structure. The flanges 400F are provided with apertures 400FA therethrough to facilitate attachment of the component 400 to a structure by means of fixing elements.

It is to be understood that the component 400 of FIG. 3 enables a bearing assembly 430B to be retained securely within a component having a reduced size compared with known components. This is because an AMC insert member 420 in the form of a tube or cylinder is provided to reinforce the component 400, the insert member 420 being capable of withstanding radial burst loading and hoop stresses.

It is to be understood that the insert member 320, 420 may be of any suitable cross-sectional shape, such as circular, square, pentagonal, hexagonal or of any other suitable shape. Other arrangements are also useful.

Embodiments of the present invention enable an anchor portion of a cast component to be strengthened and thereby made more compact by embedding in the component a reinforcement member having an aperture therein. The reinforcement member is arranged to surround at least a portion of a bore formed in the component.

The reinforcement member may be arranged to increase an amount of crush loading applied parallel to a cylinder axis of the reinforcement member that the component can withstand. In addition or instead, the reinforcement member may be arranged to increase an amount of burst loading or hoop stress that the component can withstand.

It is to be understood that metal matrix composite materials other than aluminium matrix composites are also useful. Similarly, metals other than aluminium such as aluminium alloy, magnesium alloy, aluminium magnesium alloy as well as other metals and alloys are also useful.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A method of forming an assembly comprising a component having an anchor portion and a fixing element for attaching to the anchor portion, the method comprising:
providing a metal matrix composite reinforcement member, wherein the reinforcement member comprises a tube member having a bore formed at least partially therethrough;
performing a casting operation to form a cast portion of the component, the anchor portion comprising at least a portion of the cast portion and at the reinforcement member retained by the cast portion,
the anchor portion having a bore, the reinforcement member having a longitudinal axis having at least a component thereof substantially parallel to or coincident with a longitudinal axis of the bore of the anchor portion;
inserting the fixing element through the bore of the tube member; and
applying a compressive load to the anchor portion by means of the fixing element, the compressive load having at least a component thereof parallel to an axis of the bore of the tube member.

2. A method as claimed in claim 1 wherein the reinforcement member is substantially surrounded by a portion of the cast portion of the component.

3-4. (canceled)

5. A method as claimed in claim 1 comprising providing the reinforcement member whereby the bore of the reinforcement member is substantially coaxial with the bore of the anchor portion.

6. A method as claimed in claim 1 wherein the tube member has a bore formed substantially entirely therethrough the anchor portion having a corresponding bore substantially entirely therethrough.

7. A method as claimed in claim 1 wherein the cast portion is cast such that at least a portion of the bore of the tube member is coated with cast material.

8. (canceled)

9. A method as claimed in claim 1 wherein forming the cast portion comprises casting a bearing housing whereby at least a portion of the bearing housing is provided within the tube member.

10. A method as claimed in claim 9 comprising providing a bearing assembly in the bearing housing.

11. A method as claimed in claim 1 wherein the cast portion is cast such that the bore of the tube member is substantially free of cast material.

12. A method as claimed in claim 1 comprising providing a bearing assembly in the bore of the anchor portion.

13. A method as claimed in claim 12 wherein providing a bearing assembly comprises the providing a bearing race.

14-17. (canceled)

18. A method as claimed in claim 1, wherein the fixing element comprises a bolt member, and wherein the method further comprises applying a compressive load to the anchor portion at least in part by means of a nut attached to the bolt member.

19. A method as claimed in claim 1 wherein the metal matrix composite material of the reinforcement member comprises an aluminium matrix composite material.

20. A method as claimed in claim 1 comprising forming the cast portion from a molten material comprising aluminium.

21. (canceled)

22. A method as claimed in claim 1 comprising placing the reinforcement member in a mould; and introducing molten metal into the mould to form at least a portion of a component.

23-24. (canceled)

25. An assembly comprising a component having an anchor portion and a fixing element for attaching to the anchor portion, the component comprising:
a cast portion, the anchor portion comprising at least a portion of the cast portion and at least one metal matrix composite reinforcement member retained by the cast portion,
the anchor portion having a bore, the reinforcement member having a longitudinal axis having at least a component thereof substantially parallel to or coincident with a longitudinal axis of the bore;
wherein the reinforcement member comprises a tube member having a bore formed at least partially therethrough, and the fixing element passes through the bore of the tube member and is arranged to apply a compressive load to the anchor portion.

26. An assembly as claimed in claim 25 wherein the reinforcement member is substantially surrounded by a portion of the cast portion of the component.

27-28. (canceled)

29. An assembly as claimed in claim 25 wherein the bore of the tube member passes substantially entirely through the tube member.

30. An assembly as claimed in claim 25 in combination with a bearing assembly, the bearing assembly being provided in the anchor portion.

31-32. (canceled)

33. An assembly as claimed in claim 25 wherein the metal matrix composite material of the reinforcement member comprises an aluminium matrix composite material.

34. An assembly as claimed in claim 25 wherein the cast portion comprises aluminium.

35-39. (canceled)
